(19) United States
(12) Patent Application Publication
(10) Pub. No.: US 2002/0029695 A1
(43) Pub. Date: Mar. 14, 2002

(54) Automatic barbeque assembly with bypass lever

(76) Inventors: Troy Gongwer, Wakarusa, IN (US); Dave Berkey, New Paris, IN (US)

Correspondence Address: James D. Hall, BOTKIN & LEONE, Suite 400, 105 East Jefferson Boulevard, South Bend, IN, 46601, US

(21) Appl. No.: 09/838,714

(22) Filed: Apr. 19, 2001

Related U.S. Application Data
(60) Provisional application No. 60/198,674, filed on Apr. 20, 2000.

(51) Int. Cl. A47J 37/08; A47J 37/12

(52) U.S. Cl. 99/386; 99/404; 99/443 C

(57) ABSTRACT

An automatic barbeque assembly is provided having a cooking oven, a conveyor mechanism mounted in the oven, a sauce tank mounted in the oven for holding sauce, a food carrying mechanism connected to the conveyor mechanism for carrying food products in the oven and into the sauce, and a bypass mechanism for preventing the food carrying mechanism from dipping into the sauce wherein the bypass mechanism can be activated from the exterior of the cooking oven using only one hand. The bypass mechanism includes a bypass lever and a bypass lever rod wherein the bypass lever is permanently affixed at points along the length of the bypass lever rod. The bypass lever rod is rotatably mounted within the oven. The bypass lever and bypass lever rod together form a trapezoidal shape. The bypass lever rod extends through an aperture in the oven and rotates within the aperture. An activation rod is mounted to an end of the bypass lever rod on the exterior of the oven. The activation rod has a handle for activating the bypass mechanism. A latch is provided on the automatic barbeque assembly for holding the bypass mechanism in place.

This application claims domestic priority based upon U.S. Provisional Application 60/198,674, filed Apr. 20, 2000.

### BACKGROUND OF THE INVENTION

1. Field of the Invention

The present invention relates to an automatic barbeque assembly and, more particularly, to an automatic barbeque assembly with a sauce tank for holding sauce, a mechanism for dipping food products into the sauce, a bypass lever that can be used to prevent the food products from being dipped into the sauce, and a computerized control system to precisely control the cooking process.

2. Discussion of Prior Art

Numerable methods and machines have been devised for cooking meat, poultry, and fish food products. These methods and machines use a host of cooking technologies including frying, baking, steam and broiling. Broiled meat products have become increasingly popular. This method provides a way to cook with reduced fat content and provide flavorful foods.

An automatic food cooking machine for broiling or barbequing flavorful foods is disclosed by U.S. Pat. No. 4,453,457 to Nelson Gongwer et al., incorporated herein by reference. The food cooking machine disclosed in the above mentioned patent is an energy efficient unit of a durable nature that can cook a high volume of food with exquisite flavor. The food cooking machine contains an oven with heating elements and a conveyor system for circulating the food products through the oven and past the heating elements. The food cooking machine also includes a sauce tank whereby as foods are circulated through the oven and past heating elements, the food products are also dipped into the sauce tank to enhance the flavor and texture of the cooked foods. The patent to Gongwer et al. also discloses a moveable runner that may be shifted in position over the sauce tank to prevent the food products from being dipped into the sauce while the cooked food products are being loaded into or removed from the oven.

While the moveable runner disclosed in the patent to Gongwer et al. does preclude the food products from being dipped into the sauce, the runner has limitations in that it must be positioned into place using two hands. It would be desirable to have a mechanism for preventing food products from being dipped into the sauce that can be operated using only one hand thereby allowing the operator's other hand to be free to perform other tasks.

Furthermore, the prior art rods that are used to pull the runner into position were located within the oven cavity. As such, the door of the oven had to be opened in order to pull the runners into place. As these rods were located in the oven, pulling the rods into place creates a potential bum hazard for the operator, and a generally uncomfortable work task for the operator due to the elevated temperature.

Also, the runners in the prior art extend behind the sauce tank occupying additional room in the cavity of the oven. If a mechanism for bypassing the sauce tank could be stored in the sauce tank itself, this would save space in the interior of the oven.

Alternately, it would be desirable to have an automatic mechanism for bypassing the sauce that could be controlled with a process control unit that would automatically preclude food products from being dipped into the sauce upon achievement of desired cooking specifications. Furthermore, it would be advantageous if the entire barbecue cooking process could be automated to optimize the time, temperature and other cooking conditions by inputting the type of food to be cooked in the oven.

It has been known to provide automatic controls for a cooking process. For example, there are numerous patents directed toward the deep frying process such as U.S. Pat. No. 4,320,285 to Koether; U.S. Pat. No. 4,437,159 to Waugh; U.S. Pat. No. 4,740,888 to Ceste, Sr. et al; U.S. Pat. No. 5,398,597 to Jones et al; and U.S. Pat. No. 5,776,530 to Davis et al, all of which are incorporated herein by reference. It has also been known to provide a conventional stove with programmed cooking capabilities such as is disclosed in U.S. Pat. No. 5,611,327 to Filho et al, and a microwave oven with preprogrammed cooking instructions to be selected by the user as is found in U.S. Pat. No. 5,812,393 to Drucker, both incorporated herein by reference. Additionally, it has been known to provide a remote control unit for an oven having cooking control programs such as disclosed in U.S. Pat. No. 4,837,414 to Edamula, and an automatic cooking apparatus which sequentially enters numerous food items into various cooking pots and introduces liquid ingredients and then cooks food in accordance with a specified computer program as is disclosed in U.S. Pat. No. 5,881,632, both incorporated herein by reference. Also, an example of a cooking appliance interface for interfacing a cooking computer to a cooking unit such as an oven or fryer is disclosed in U.S. Pat. No. 5,043,860 to Koether et al, incorporated herein by reference. Lastly, it has been known to provide an oven having a conveyor system capable of being programmed to cook particular food products by changing the speed of the conveyor and providing a plurality of cooking regions with various temperatures as is shown in U.S. Pat. No. 5,253,564 to Rosenbrock et al, incorporated herein by reference. However, none of the prior art provides an automatic system for alternately dipping and bypassing food products in a sauce tank as well as numerous other control features associated with the present invention.

It is therefore an object of the invention to provide a food cooking machine or automatic barbeque assembly with a sauce tank and an improved mechanism to allo<< the food products to bypass the sauce tank. In particular, a sauce tank bypass mechanism is needed which can be operated with one hand from the exterior of the oven and which minimizes the storage space required for the bypass mechanism within the oven cavity.

Alternately, it is an object of the invention to provide a food cooking machine having an automatically controlled mechanism to allow food products to bypass the sauce tank. Furthermore, it is an object of the invention to provide the machine with a completely controlled cooking process based upon inputting the food products to be cooked into a process control unit.

### SUMMARY OF THE INVENTION

The invention has been accomplished by providing an automatic barbeque assembly having a cooking oven, a conveyor mechanism mounted in the oven, a sauce tank mounted in the oven for holding sauce, a food carrying mechanism connected to the conveyor mechanism for carrying food products within the oven and into the sauce, and a bypass mechanism for preventing the food carrying mechanism from dipping the food products into the sauce wherein the bypass mechanism can be activated from the exterior of the cooking oven using only one hand.

It is a further feature of the invention to have the bypass mechanism include a bypass lever and a bypass lever rod whereby the bypass lever is permanently affixed to the bypass lever rod. The bypass lever rod is rotatably mounted within the oven. The bypass lever and bypass lever rod together form a trapezoidal shape.

An additional feature of the invention is to have the bypass lever rod extend through an aperture in the oven and to rotate within the aperture. An activation rod is mounted to the bypass lever rod on an end of the bypass lever rod that is located on the exterior of the oven. The activation rod has a handle for activating the bypass mechanism. The invention includes a latch on the automatic barbeque mechanism assembly for holding the bypass mechanism in place.

It is a feature of another embodiment of the invention to provide an automatic bypass mechanism for preventing the food carrying mechanism from dipping the food products into the sauce wherein the bypass mechanism will be activated upon the cooking oven obtaining preset cooking conditions.

It is also a feature of the invention to provide an automatic barbecue assembly having an automatic start sequence to bring the oven to a preset temperature. The oven includes a conveyer driven by a motor and a torque sensitive coupler such that if a preset torque is exceeded the coupler will disengage. If the coupler disengages, a sensor will pick up the event and the process control unit will sound an alarm.

It is another feature of the invention that the position of the conveyer can be sensed such that an operator can identify if food carrying baskets are empty or loaded. When an empty basket arrives in a load position the conveyor stops and allows the operator to load food products into the empty basket.

Another feature of the invention is that an operator selects the appropriate food product, which was loaded into the empty basket, such that the process control unit will initiate a preset cooking sequence for the food product that was selected. The operator has a preset amount of time to change the food product selection, if the wrong selection is accidently pushed.

It is also a feature of the invention that associated with each product selector switch is a preset amount of degrees minutes as well as a preset count for dipping the food product into the sauce and also bypassing the sauce.

Another feature of the invention is that when the food product in a particular basket has reached the preset conditions and cooking is completed, an audible alarm sounds as the basket nears the end load station and again when the basket stops at the load station for the operator to check the product. After the product is checked, the operator may either unload the product or reload the product and press “one more” so that the conveyor will circle the product one more time through the oven.

Another feature of the invention is that the oven temperature is constantly monitored such that the cooking control unit will regulate the flow of air past the gas mixer to increase or decrease the temperature in accordance with the preset amount. Barbecue assembly includes a water valve that opens in short bursts if the temperature in the oven becomes too high as a result of grease fires.

Lastly, it is a feature of this invention that the process control unit includes a machine wash cycle such that each part of the wash cycle is timed.

### BRIEF DESCRIPTION OF THE DRAWINGS

FIG. 1 is a side view of the food cooking machine with a partial section removed depicting the bypass mechanism in an inactivated position so that food products being conveyed within the oven will dip into the sauce.

FIG. 1a is a side view of a food cooking machine with a partial section removed depicting a bypass mechanism in an activated position to prevent food products from being dipped into the sauce.

FIG. 2 is a partial isometric view of the food cooking machine through an opening showing the bypass mechanism in the inactivated position.

FIG. 2a is partial isometric view of the food cooking machine through the opening showing the bypass mechanism in the activated position to prevent food products from being dipped into the sauce.

FIG. 3 is a perspective view of an alternate embodiment of the invention showing the barbeque assembly unit with a cooking or process control unit.

FIG. 4 is a partial bi-symmetric view of the barbeque assembly with an automatically controlled bypass lever.

FIG. 5 is a front view of the process control unit and process control panel.

FIG. 6 is a schematic of the process control for the automatic barbecue cooking assembly.

FIG. 7 is a generalized flow chart of the main routine for the process control unit.

FIGS. 8a and 8b show a flow chart of a sub routine of the starting sequence of the process control unit.

FIG. 9 is a flow chart of a sub routine for the loading sequence of the process control unit.

FIGS. 10a and 10b show a flow chart of a sub routine for the cooking sequence for the process control unit.

FIG. 11 is a flow chart of a sub routine for temperature control of the process control unit.

FIG. 12 is a flow chart of a sub routine of the wash cycle of the process control unit.

### DETAILED DESCRIPTION OF THE PREFERRED EMBODIMENTS

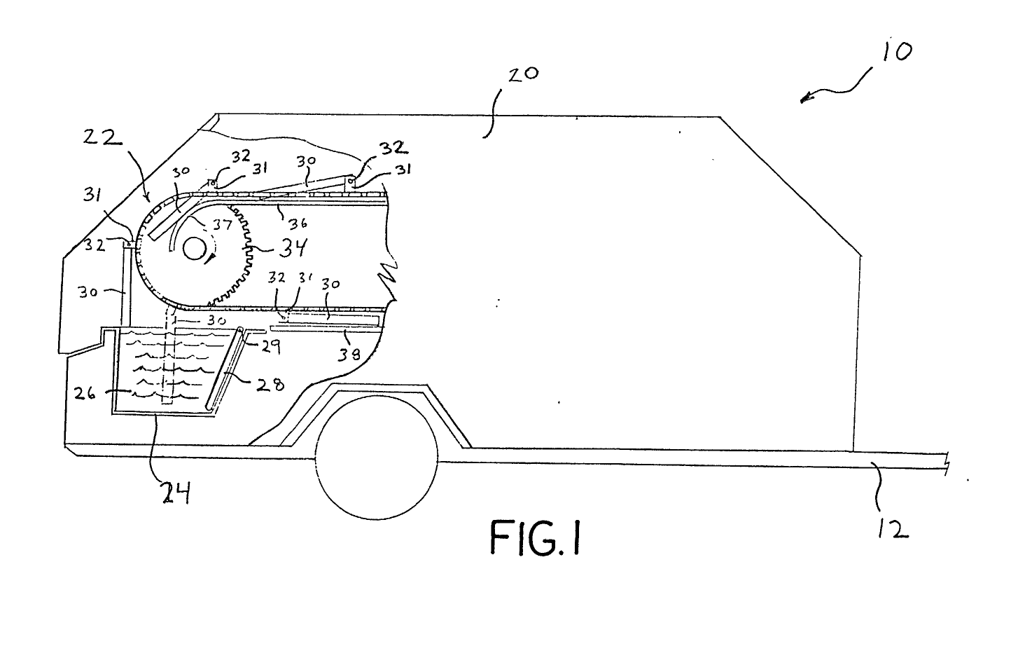

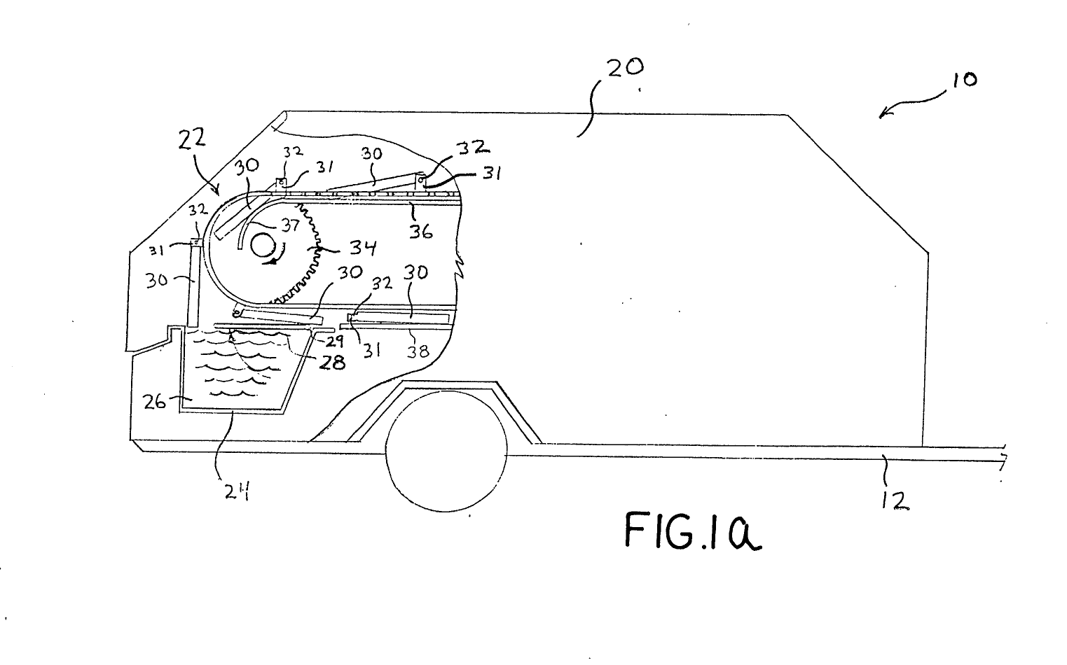

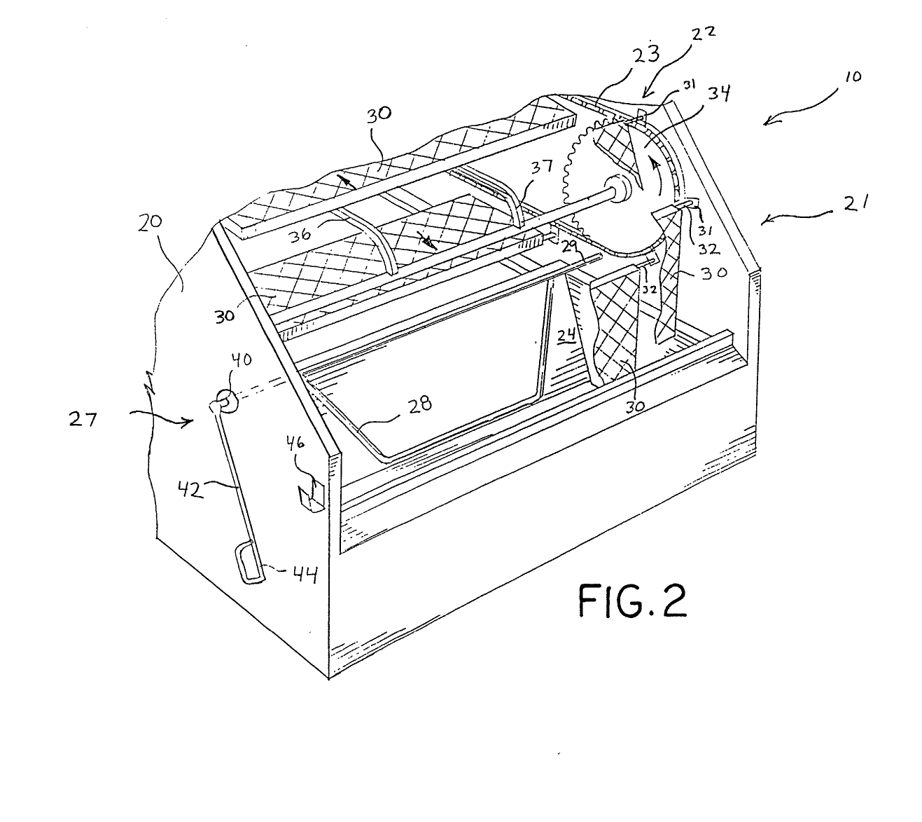

FIGS. 1 and 2 illustrate the preferred embodiment of an automatic barbeque assembly 10. Assembly 10 includes a cooking oven 20, a conveyor mechanism 22, a bypass mechanism 27, and a supporting frame 12.

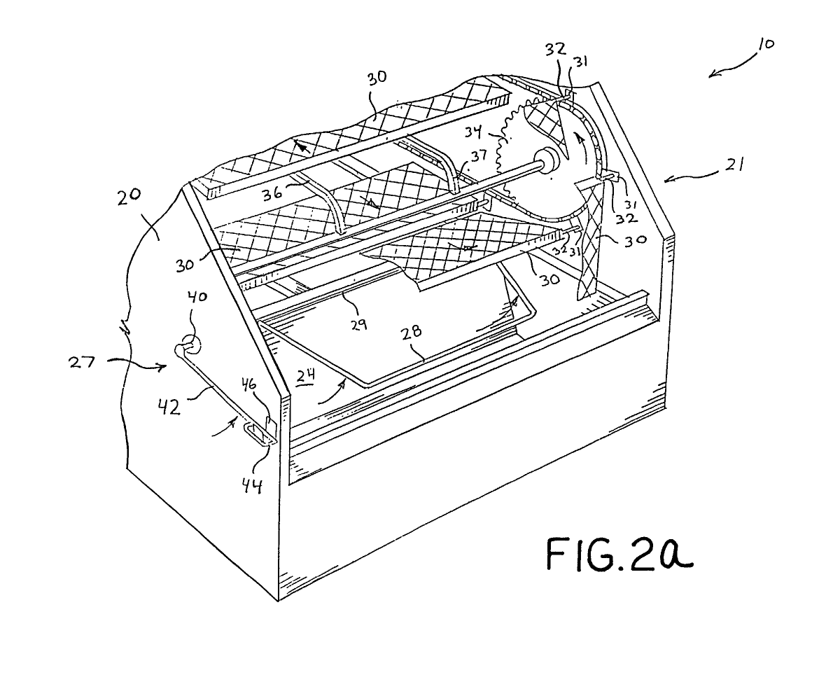

Oven 20 may be of any suitable size, shape and material; however, in the preferred embodiment the oven is shaped substantially as a rectangular box. The oven may be made out of stainless steel and have insulated sidewalls to hold in heat. Oven 20 has an opening 21 located at an end of oven 20 for loading and unloading food products (not shown). The opening can be closed with a door 116 (FIG. 3) to hold heat and moisture within the oven. Within oven 20 is a sauce tank 24 as will be described in greater detail herein, which is used to hold the sauce 26.

Conveyor mechanism 22 includes a driving chain 23 and sprocket 34, which carry food carrying mechanisms 30 within oven 20, where the food mechanisms 30 are attached to conveyor mechanism 22 by rods 32 and lugs 31. Food carrying mechanisms 30 are guided through the oven on an upper rail 36 and a lower rail 38. Upper rail 36 has a curved end 37 to facilitate the smooth transition of food carrying mechanisms 30 from a vertical hanging position when going around sprocket 34 to a horizontal position on upper rail 36.

With respect now to FIG. 2, the bypass mechanism 27 is shown including a bypass lever 28, a bypass lever rod 29, and an activation rod 42 located on the exterior of oven 20. Bypass lever 28 consists of a bent rod permanently affixed to bypass lever rod 29 by welding or other suitable means, whereby the bypass lever 28 forms a trapezoidal shape in conjunction with bypass lever rod 29. Bypass lever rod 29 is rotatably mounted within oven 20, wherein one end of bypass lever rod 29 is extended through an aperture 40 in a sidewall of oven 20, rotating therein. The other end of bypass lever rod 29 is rotatably mounted to an interior sidewall of oven 20. Activation rod 42 is affixed by welding threaded attachment or other suitable means to the end of bypass lever rod 29 that extends outside of oven 20. A handle 44 is formed on the end of activation rod 42. A latch 46 is fixed to the outside of oven 20 for purposes of locking bypass mechanism 27 into a fixed position.

Conveyor mechanism 22 is powered by a motor 125 (FIG. 3) preferably located on the exterior of the oven 20. The motor drives sprocket 34 in the direction of the arrow shown thereon creating a translation of chain 23. Chain 23 integrates with another freely rotating sprocket (not shown) to the rear of the oven for supporting and maintaining proper tension on chain 23. Food carrying mechanisms 30 consist of stainless wire mesh baskets or other suitable means for holding the food products as they are carried through the oven 20 and cooked. Food carrying mechanisms 30 are secured to and rotated with chain 23 by carrier rods 32 and lugs 31.

With the device as described above, the operation will now be described in detail. As food carrying mechanisms 30 are attached to the chain 23, when the motor drives conveyor mechanism 22, the food carrying mechanisms 30 are carried throughout oven 20 guided by the upper rail 36 and lower rail 38. As shown in FIG. 1, as food mechanisms 30 are carried near sprocket 34 mechanisms 30 dip into sauce tank 24 thereby coating the food products (not shown) in mechanism 30 with sauce 26 to provide flavor and texture to the food products. Bypass mechanism 27 is provided as a means to prevent food mechanisms 30 from dipping into sauce 26 as is desirable when loading and unloading the food products in oven 20. In FIGS. 1 and 2, bypass mechanism 27 is shown in the inactivated position thereby allowing food products to be dipped into sauce 26. In this position, bypass lever 28 is located within sauce tank 24 and sauce 26.

In FIGS. 1a and 2a, the bypass mechanism is shown in the activated position, that is rotated to prevent food carrying mechanisms 30 from dipping into sauce 26. Bypass mechanism 27 is activated by an operator pulling handle 44 and moving the activation rod in a direction shown by the arrows in FIG. 2a. When activation rod 42 is pulled up, bypass lever rod 29 rotates in aperture 40 until bypass lever 28 is rotated out of the sauce and into a horizontal position overlying the tank. Bypass mechanism 27 may be locked into an activated position by placing handle 44 in latch 46. While bypass mechanism 27 is in the activated position, food carrying mechanisms 30 rest on and glide upon bypass lever 28 thereby preventing the food products from dripping into sauce tank 24.

Frame 12 may be integral with or attached to a trailer so that the automatic barbequing mechanism 10 may be transported to a desired location. It is to be appreciated that numerous variations from the example of the preferred embodiment described herein may be made without departing from the scope of the invention. For example, the shape of bypass lever 28 may be varied to any shape as long as it prevents food carrying mechanisms 30 from dipping into sauce 26. Furthermore, bypass lever 28 may be manufactured from a plate instead of a bar.

Additionally, as shown in FIG. 2, latch 46 is made from a strip of metal bent in a U-shaped configuration; however, any latching mechanism may be used that will hold the bypass mechanism in the activated position. In the preferred embodiment, a latching mechanism is not required to hold the bypass mechanism in the inactivated position as the bypass lever 28 rests against the back of sauce tank 24.

Now referring to FIG. 3 an alternate embodiment automatic barbecue assembly is shown generally as 110. Barbecue assembly 110 has the same basic structure as barbecue assembly 10 and includes a frame 112, an oven 120 and a sauce tank 124. Barbecue assembly 110 also includes a driving motor 125 to drive a conveyor mechanism 122, said conveyor mechanism including a drive chain 123 sprockets 134 and food carrying mechanisms or baskets 130. Conveyor mechanism 122 carries said baskets throughout the oven to cook a food product (not shown) contained therein.

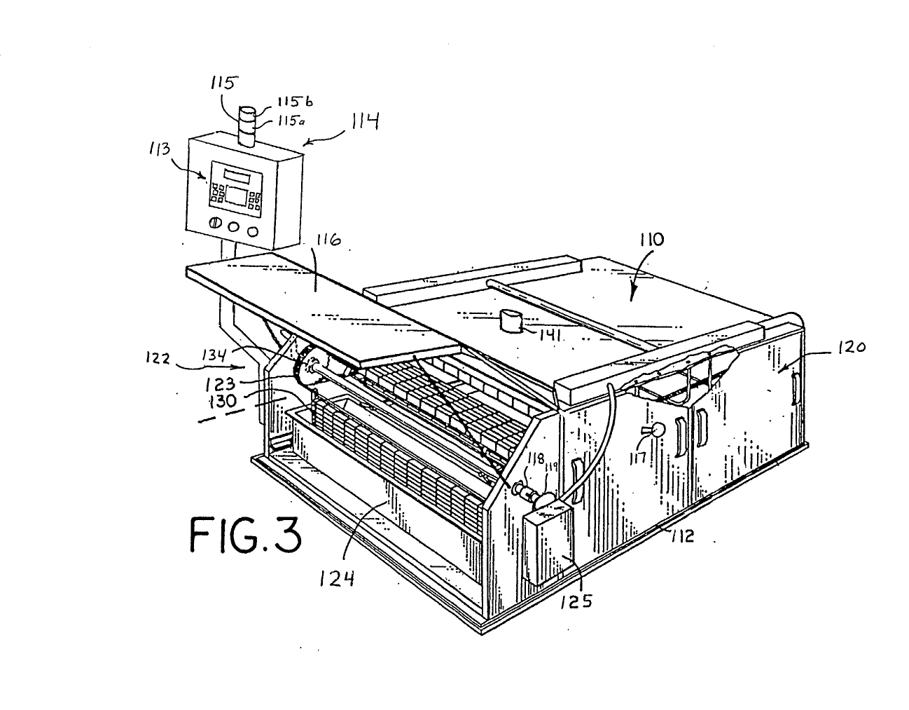

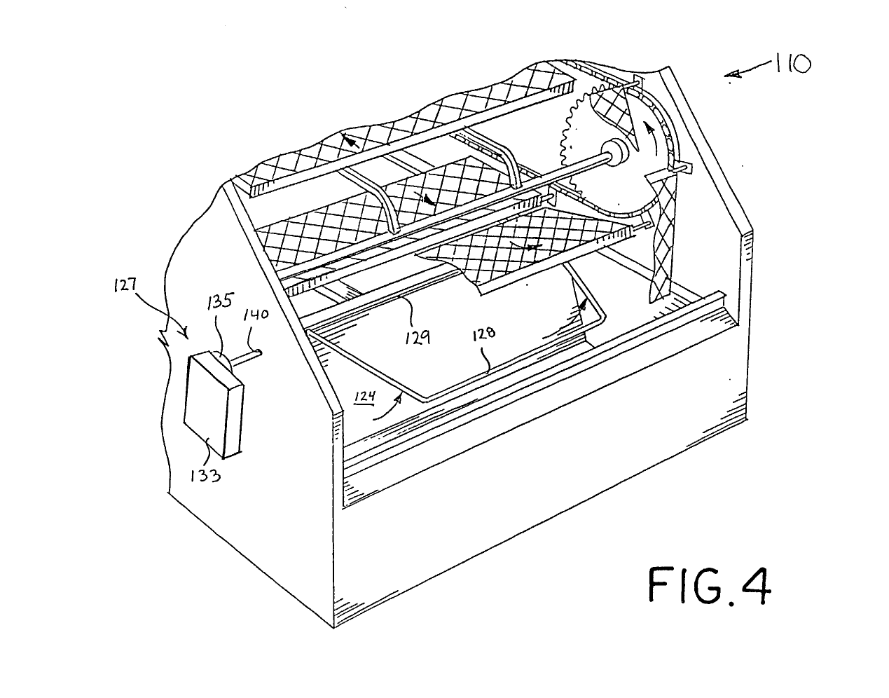

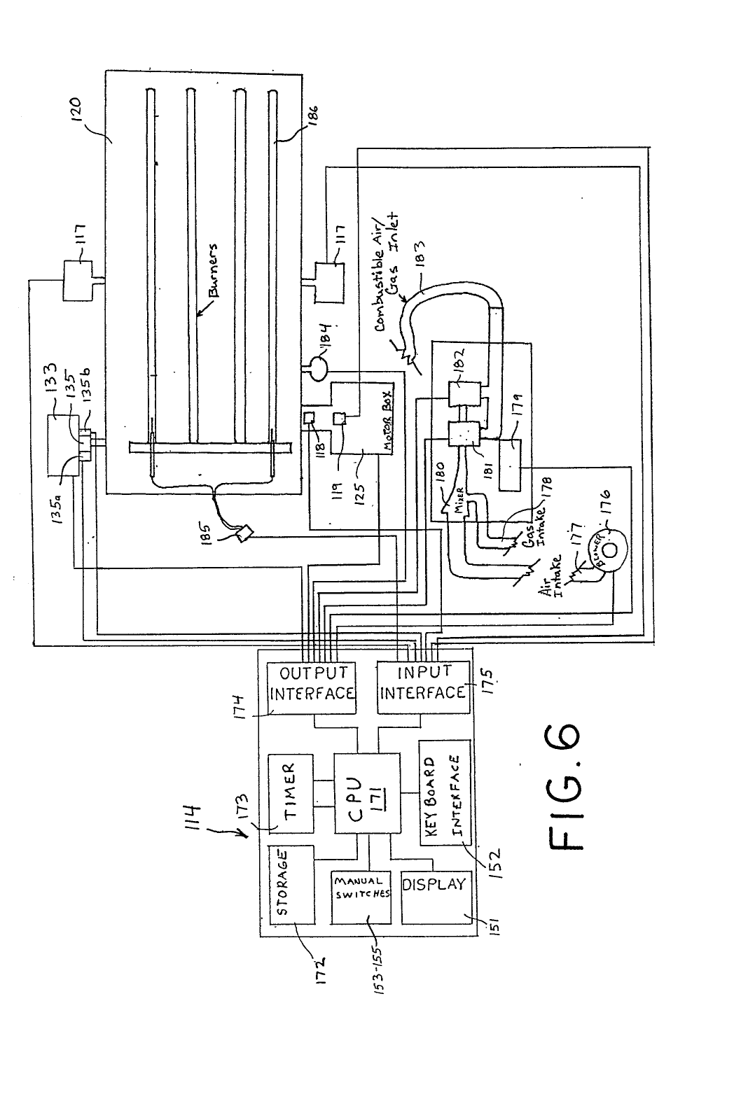

Barbecue assembly 110 also includes a cooking or process control unit 114 having a control panel 113 and an illuminated signal system 115. The signal system has a green light 115a and a red light 115b. Automatic barbecue assembly 110 also includes a pair of temperature sensors 117, one each being mounted on opposing sides of oven 120, a clutch proximity sensor 118, and a conveyor location proximity sensor 119. As can be seen in FIG. 4, barbecue assembly 110 has a bypass mechanism 127 to allow the food products to bypass the sauce tank 124. Bypass mechanism 127 includes a bypass lever 128, a bypass lever rod 129 and an aperture in the oven 140 through which bypass lever rod 129 passes. In addition, bypass mechanism 127 includes a bypass motor 123 and bypass position sensor 125, having a bypass UP proximity sensor 125a and a bypass down proximity sensor 125b (FIG. 6). A fitting 141 is attached to the top of oven 120 for connection to a cleaning fluid to be used when the oven is run through an interior wash cycle.

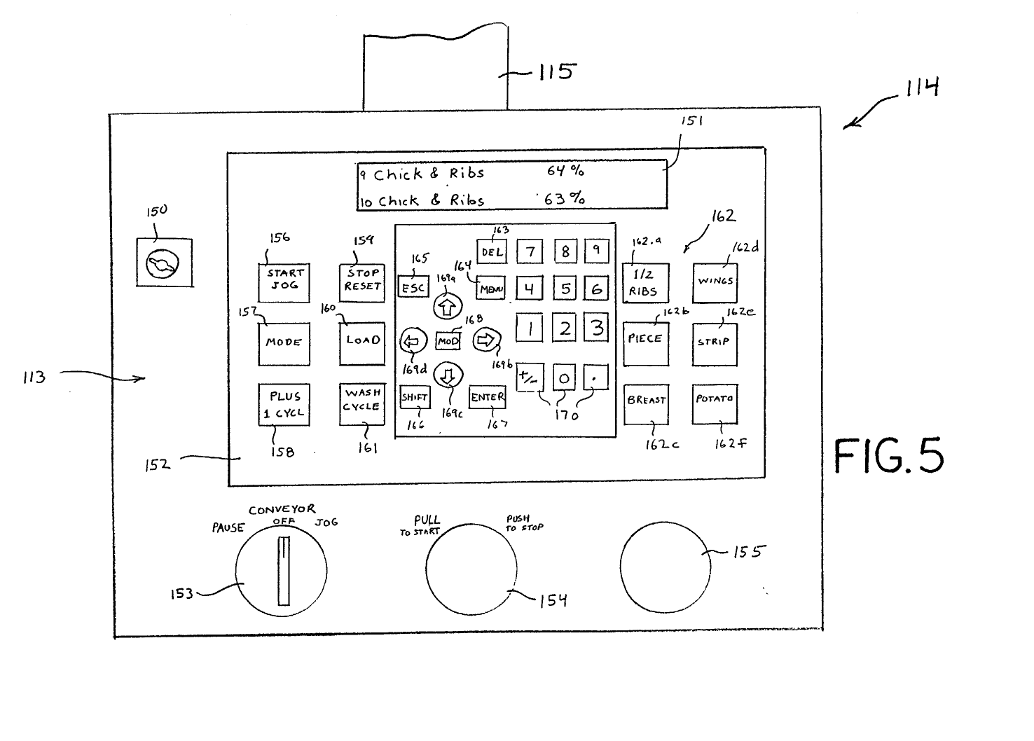

Now referring to FIG. 5, the external details of cooking control unit of 114 are depicted. Control panel 113 includes a key lock 150 and a liquid crystal display (LCD) 151 for showing the program entries and current cooking progress of the food products in the oven. Control panel 113 also has an input or keyboard pad 152 for programming the barbecue assembly. Also included on control panel 113 is a manual conveyor control 153, a start/stop button 154 and an emergency stop button 155.

The preferred embodiment input pad 152 includes numerous controls for the oven including start input 156, a mode selection 157, a plus one cycle 158, a stop/reset selection 159, a load selection 160 and a wash cycle 161. The input pad also includes food product selection inputs 162 with the preferred embodiment including individual selections for 1/2 chicken or ribs 162a, individual pieces of chicken 162b, chicken breasts 162c, chicken wings 162d, chicken strips 162e, and potato slices 162f. The central portion of the input pad includes delete input 163, a menu pull-up 164, an escape input 165, shift input 166, and enter input 167, modify 168 and arrow control selections 169a-d.

Now referring to FIG. 6, it can be seen that cooking control unit 114 includes a central processing unit (CPU) 171, which interacts with the display 151, the keyboard interface 152, the manual switches 153-155, storage circuitry 172, a time 173, an output interface 174 and an input interface 175. Through output interface 174, CPU 171 controls an air blower 176, a spark control unit 179, low and high gas flow solenoid valves 181 and 182, a water solenoid 184, motor 125, and motor 133. In order to control these components attached to the output interface, central processing unit utilizes data received from keyboard interface 152, manual switches 153-155, storage circuitry 172, and information received from the outside of cooking control unit 114 through input interface 175. Through input interface 175; CPU 171 receives information from clutch proximity sensor 118, location proximity sensor 119, temperature sensors 117, bypass position sensors 135a and 135 and a spark sensor 186.

When blower 176 is activated, air is pushed through an air intake 176 to be mixed with a combustible gas from a gas intake 178 in gas/air mixer 180. From the mixer, the gas/air mixture flows through combustible air/gas inlet 183 to burners 186 located in oven 120. The mixture is ignited by spark control 179 and spark sensor 185 senses whether the burners has been ignited. If neither of gas flow valves 181 or 182 is opened the burners will receive enough of the gas/air mixture to maintain a flame but not to take the unit into the cooking range temperature. To increase the temperature rapidly, high control valve 182 can be opened to maximize the gas mixture flow. Once the preferred temperature range has been reached, high flow gas valve 182 is turned off and low control gas valve 181 is turned on. Under normal operating conditions, gas control valve 181 will maintain oven 120 at the proper cooking temperature.

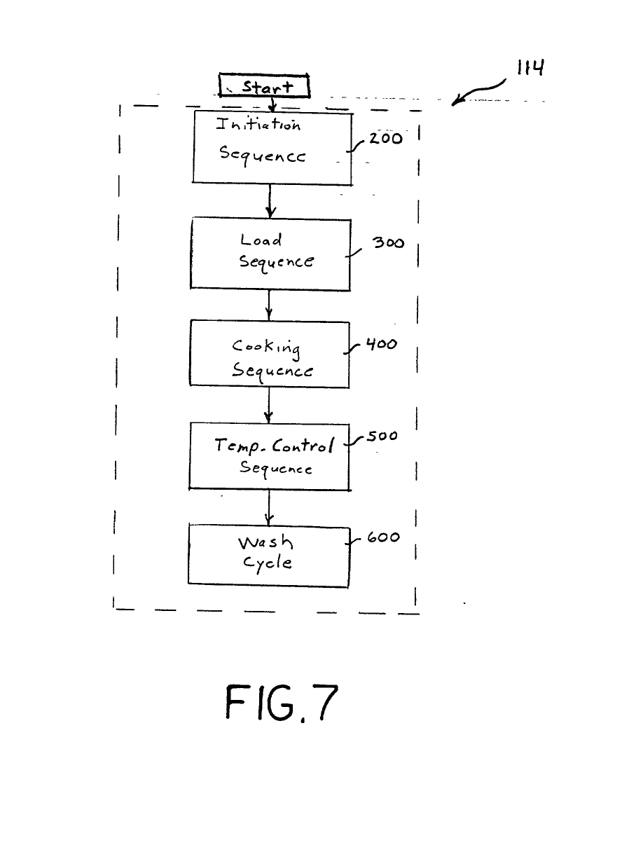

Having described the component parts and the assembly, the operation of barbecue assembly 110 and cooking control unit 114 will now be described. As shown in FIG. 7, cooking control unit 114 performs the following operations including an initiation sequence 200, a load sequence 300, a cooking sequence 400, a temperature control sequence 500, and a wash cycle 600.

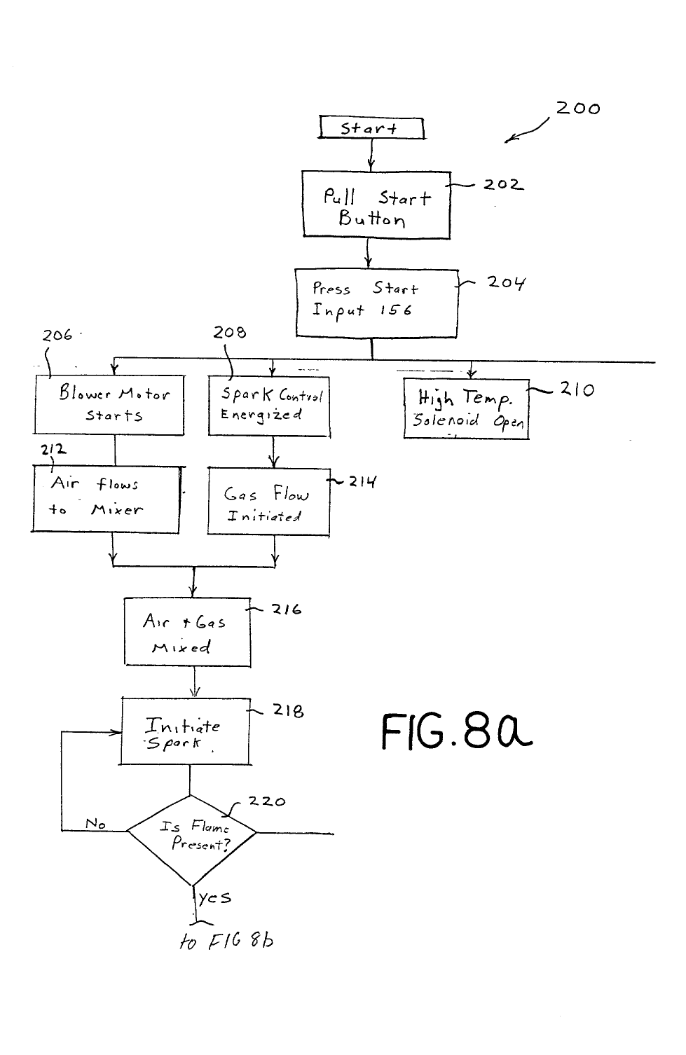

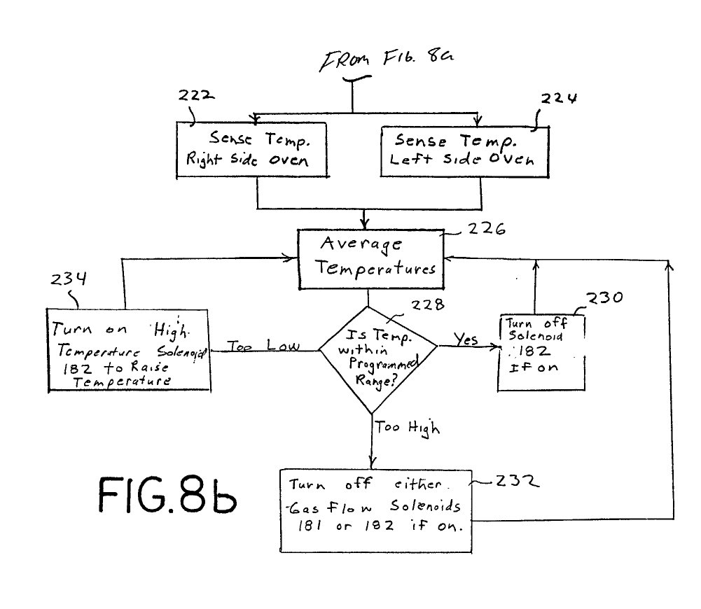

The subroutines of the initiation sequence 200 and subsequent temperature control process of oven 120 are shown in the flow chart in FIG. 8a and 8b. Operation of barbecue assembly 110 is initiated by pulling start button 154 and step 202. In step 204, the input start button 156 is pressed to simultaneously turn on the blower motor 176 step 206, energize spark control 179 in step 208, and open the low temperature valve 181 in step 210. The blower blows air through the air intake 177 and to mixer at 180 as shown in step 212, while the spark control initiates gas flow through gas intake 178 into mixer 180 as shown in step 214. In step 216, the air and gas are mixed in mixer 180. The air and gas mixture flows through inlet 183 into burners 186 of oven 120 whereupon spark control 179 initiates a spark as shown in step 218. In step 220, sensor 185 detects whether a flame has been initiated and, if not, step 218 is repeated. Once a flame is present, temperature sensors 117 monitor the temperature on opposing sides of the oven as shown in steps 222 and 224. CPU 171 averages the temperatures in step 226 and determines whether the temperature is in the preprogrammed range as shown in step 228. If the temperature is within the range in step 230, high temperature gas flow solenoid 182 is off, if it is on so that the burners will operate at their normal or midrange heating capacity with only low temperature gas flow solenoid 181 on in order to maintain the temperature within the programmed range. If the temperature in the oven is too high, as may occur during a grease fire, both gas flow solenoid valves 281 and 282 are turned off so that the temperature of the oven will drop back into the programmed range. If the temperature is too low as shown in step 234, the high temperature solenoid valve 182 is turned on, to increase the temperature of the oven within the programmed cooking range. After each of the applicable steps 230, 232, or 234, step 226 is repeated so that the average temperature in the oven is checked at selected programmed intervals.

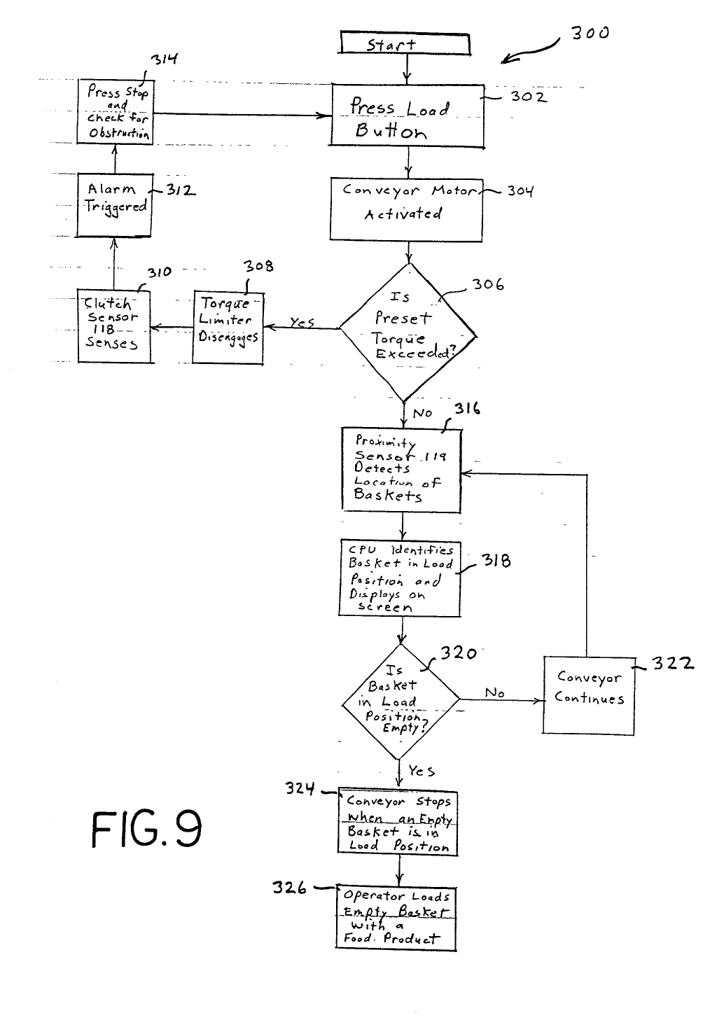

Now referring to FIG. 9, subroutines load sequence 300 are shown. Load sequence 300 starts by an operator pressing mode button 160 as shown in step 302. This activates the conveyor motor in step 304. The next step 306 relates to the torque incurred on the drive shaft when conveyor motor 125 is activated. If the preset torque is exceeded, a torque limiter disengages the conveyor drive step 308, which is sensed by clutch sensor 118 in step 310. This information is relayed back to CPU 171 as shown in step 312 and an alarm is triggered to alert the operator. Then, as shown in step 314, the stop button is pressed allowing the operator to check for obstructions or other malfunctions with the conveyor system. After the conveyor is ready again and the torque limiter engaged, the operator then presses the load button, again starting the sequence in step 302. If the preset torque is not exceeded, the conveyor will rotate as shown in step 316 and proximity sensor 119 detects the location of the baskets. CPU 171 identifies which basket is in the load position and tracks the baskets with information relayed from conveyor location proximity sensor 119 and displays the information on display 151. As shown in step 320, if the basket in the load position is not empty, the conveyor will continue to travel to bring another basket to the load position as in step 322 thereby sequencing back to step 316. When an empty basket has reached the load position the conveyor will stop as in 324 and alert the operator. At this point, as in step 326, the operator will load the basket with the food product. The sequence is repeated until all selected baskets are filled with food product.

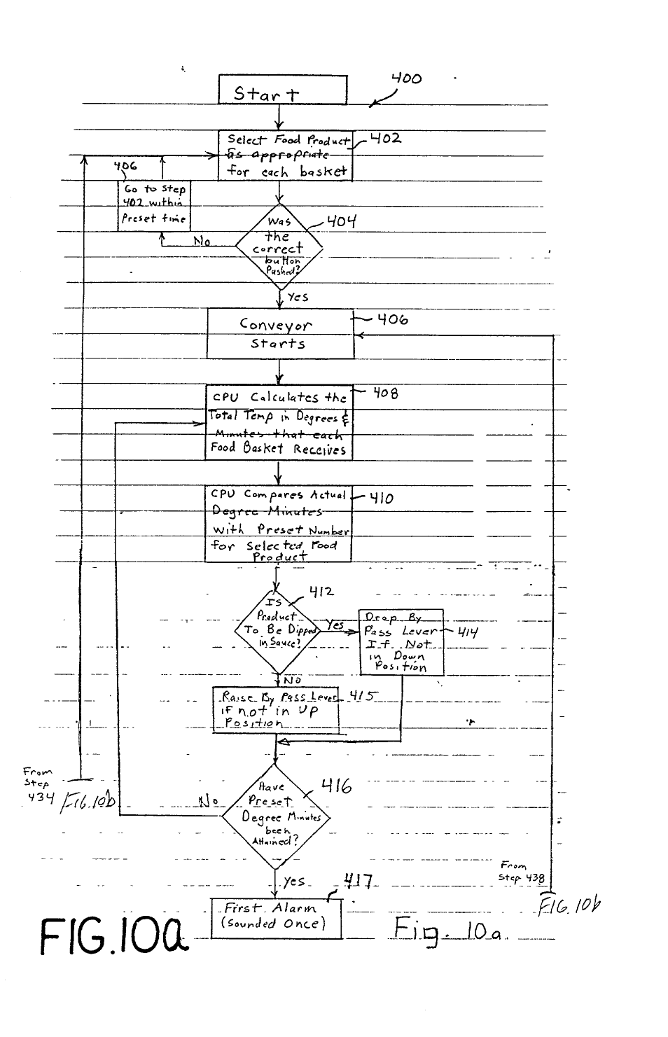

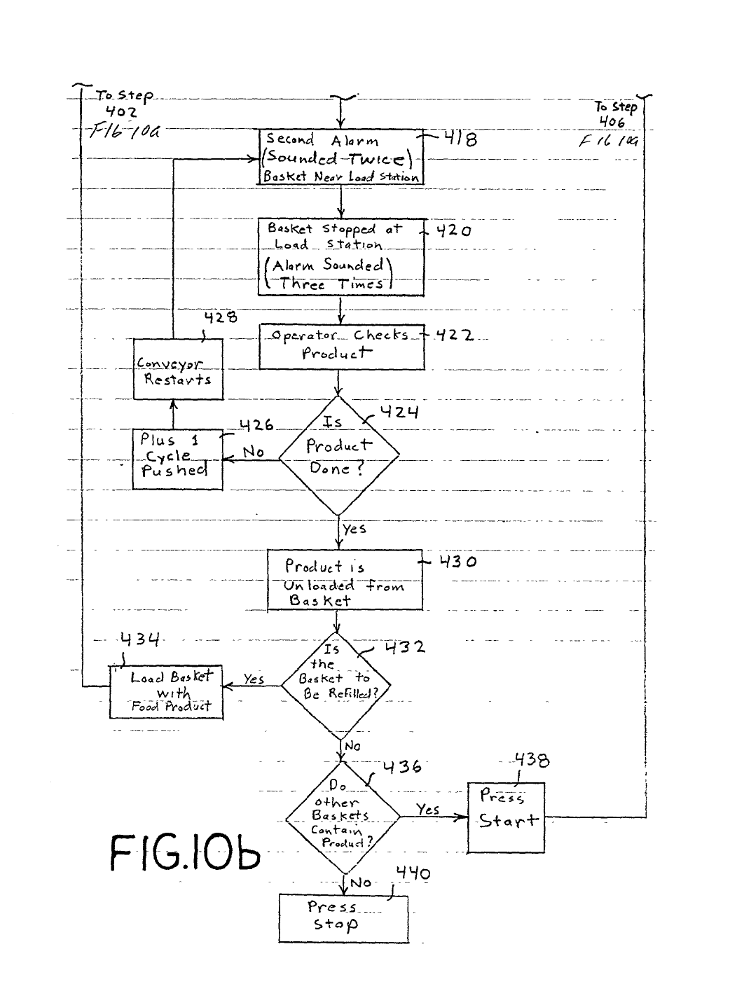

As can be seen from FIGS. 10a and 10b, the subroutine for cooking sequence 400 is shown. Cooking sequence 400 begins at step 402 wherein the food product which has been loaded into a basket in sequence 200 is selected on input pad 152 using one of the selection keys 162a-f. If the correct button was not selected, step 404, as shown in step 406 the proper food product can be re-selected. Once the proper food product has been pressed, the conveyor automatically starts at a preselected time interval as in step 406. CPU 171 then calculates and adds the total minutes and temperature (or total BTU's of heat) to which the food product was disposed to as in step 408. In step 410 the CPU compares this total actual degree minutes to an actual number selected for the selected food product. As shown in step 412, the CPU also determines whether the food product should be dipped into the sauce when passing sauce tank 124. Location proximity sensor 119 provides the information to the CPU to determine which basket is in location to be dipped. If the food is to be dipped in the sauce, the bypass lever 128 will be lowered if it is not already down as shown instep 214. On the other hand, in step 415 if the product is not to be dipped in the sauce, the bypass lever will be raised, if is not already up. Then, in step 416, the CPU determines if the preset degrees/minutes have been attained for each product in each basket. If the preset number has not been reached, steps 408-415 are repeated. The CPU will continue to calculate the degree minutes the food product is exposed to in accordance with the preset value and whether the food products should be dipped into the sauce tank on each subsequent trip through the oven. Once the total degree minutes for the food product has reached the preset number, a single alarm will be sounded in step 416. As the basket with the food product having reached the preset number nears the load station, a second alarm will be sounded twice as in step 418. When this basket has reached the load station, the conveyor will stop and the alarm will sound three times as in step 420. At this point, the operator checks the product in step 422 to see if it is done. As in step 424, if the product is not done, the plus one cycle is pushed step 426, the conveyor will restart step 428 at which point steps 418-422 will be repeated. Once the food product is completely cooked, it will be unloaded from the basket as in step 430 and the operator will determine if the basket is to be refilled step 432. If the basket is to be reloaded with more food product, the operator will reload the basket as in step 434 and the cooking sequence will be restarted at step 402. In step 436 if the basket is not to be refilled, but other baskets still contain food product the operator will press start button in step 438 whereupon the conveyor will start as in step 406 and steps 408-436 will be repeated for the remaining baskets containing food product. If all the baskets containing food product have been unloaded, and are not presently to be reloaded, the stop button is pressed as in step 440.

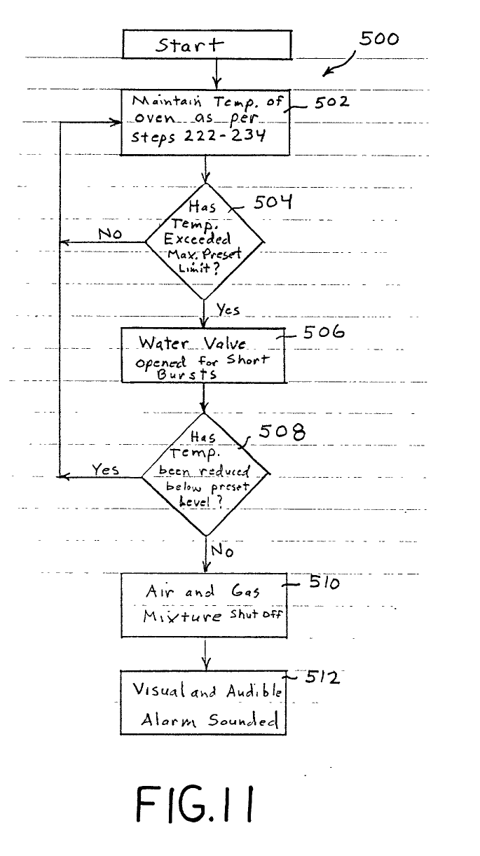

The subroutine for temperature and safety sequence 500 is shown in FIG. 11. In step 502 the temperature of the oven is maintained in accordance with steps 222-234 of the subroutine for initiation sequence 200. As shown in step 504, if steps 222-234 are successful in maintaining the temperature in a desired range these steps will be repeated. However, if steps 222-234 are not successful in keeping the temperature of the oven below a preprogrammed maximum setting, CPU 171 will turn on water valve 184 in short bursts to extinguish or reduce a grease fire within the oven 120 as in step 506. The control unit may also be programmed to stop any dipping of the food product during this time. In step 508 if the temperature has been reduced below the preset level then step 502 is repeated. If, however, the bursts of water are not successful in sufficiently lowering the temperature; as shown in step 510, CPU 171 will shut off the air/gas mixture flowing to the oven. At this point a visual and audible alarm will be sounded as in step 512.

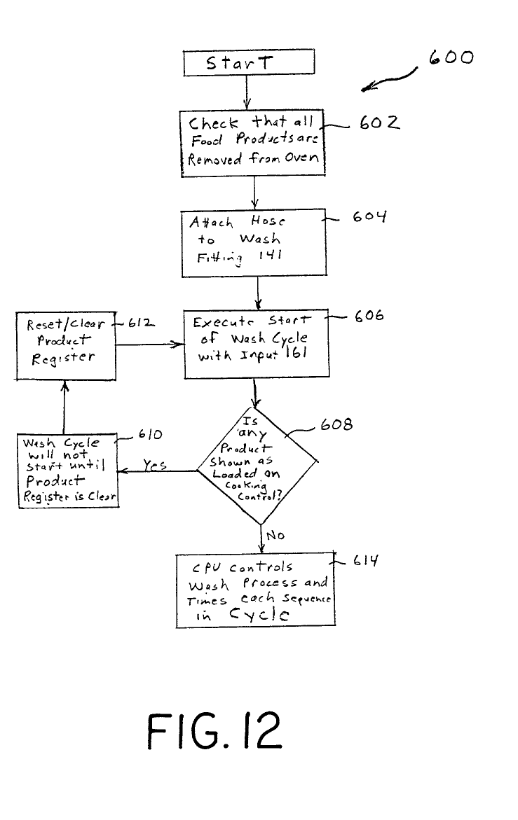

Referring now to FIG. 12, the subroutine of wash cycle 600 is depicted. First, in step 602 the operator checks that all food products have been removed from oven 120, and then a hose (not shown) for injecting a cleaning fluid into oven 120 is attached at fitting 141 as shown in step 604. The wash cycle is started by pushing the wash cycle input 161 as in step 606. As shown in step 608, if any product is still showing as registered in CPU 171 which has been entered for a basket on one of input keys 162 and not completed and removed, the wash cycle will not start as indicated by step 610. At this point, the operator would check again to assure that all food products have been removed and reset or clear the food product register in step 612, after which step 606 is repeated. Once the wash cycle starts, CPU 171 will control the wash process and time each sequence in the wash cycle.

It should also be understood that numerous variations can be made to the above embodiments without departing from the spirit and scope. For instance, the gas flow solenoid valves could be arranged differently from the depiction in FIG. 6 such as placing the valves in line before the mixer or branching the lines in a different manner. It would also be possible to use only one valve, more than two valves, one or more variable gas flow valves, or possibly no valve at all.

It should also be noted that cooking control unit 114 could take on almost any configuration as with input pad 152. Also, the proximity sensors may be of any type that are none in the art such as magnetic, resistance, Hall effect, or optical. Magnetic sensors are used in the preferred embodiment due to their durability. Also, it should be realized that the location and number of sensors providing input into CPU 171 could be varied as desired and upon configuration of the cooking oven. It should also be recognized that although selected food products have been indicated on input pad 152, that the type and number of food products and associated cooking program for the food products can be varied as desired.

In addition, although the cooking control system 141 is shown as utilized with a conveyored barbecue system, it would be possible to use this unit with other cooking processes such as baking, deep frying, or microwave cooking. Furthermore, although combustible gas provides the heat source in the preferred embodiment, any suitable heat source may be substituted.

Furthermore, those skilled in the art will appreciate that the conception, upon which this disclosure is based, may readily be used as a basis for the designing of additional structures, methods and systems other than above for carrying out the several purposes of the present invention. Further, the abstract is neither intended to define the invention of the application, which is measured by the claims. Neither is the abstract intended to limit the scope of the invention in any way.

1. An automatic barbecue assembly, comprising a cooking oven, a conveyor mechanism mounted in the oven, a sauce tank mounted in the oven for holding sauce, a food carrying mechanism connected to the conveyor mechanism for carrying food products within the oven and into the sauce tank so as to dip the food products in the sauce, and a bypass mechanism having a bypass lever pivotally mounted within the oven so as to prevent the food carrying mechanism from dipping into the sauce tank when the lever is pivoted to a horizontal position.

2. The automatic barbeque assembly of claim 1 wherein the bypass lever is located within the sauce tank when the lever is in an inactivated position that allows food products to be dipped into the sauce.

3. The automatic barbeque assembly of claim 1, further comprising a bypass lever rod serving as the pivotable mount for the bypass mechanism.

4. The automatic barbeque assembly of claim 3, wherein the bypass lever comprises a bent bar permanently affixed to the bypass lever rod.

5. The automatic barbeque assembly of claim 4, wherein the bypass lever and bypass rod form a trapezoidal shape.

6. The automatic barbeque assembly of claim 3, wherein an end of the bypass lever rod protrudes through an aperture in the oven and rotates therein.

7. The automatic barbeque assembly of claim 6, further comprising an activation rod mounted to the end of the bypass lever rod for pivoting the bypass lever.

8. The automatic barbeque assembly of claim 7, wherein the activation rod includes a handle for easily gripping the bypass activation rod and pivoting the bypass lever. The automatic barbeque assembly of claim 1, further comprising a latch to lock the bypass lever in position.

9. An automatic barbecue mechanism assembly, comprising a cooking oven, a conveyor mechanism mounted in the oven, a sauce tank mounted in the oven for holding sauce, a food carrying mechanism connected to the conveyor mechanism for carrying food products to be cooked within the oven and into the sauce tank so as to dip the food products into the sauce, and a bypass mechanism rotatably mounted within the oven for preventing the food carrying mechanism from dipping into the sauce tank when the bypass mechanism is rotated into position.

10. The automatic barbeque mechanism assembly of claim 10, wherein the bypass mechanism comprises a bypass lever permanently affixed to a bypass lever rod.

11. The automatic barbeque mechanism assembly of claim 11, wherein a portion of the bypass lever rod extends through an aperture in the oven and rotates therein.

12. The automatic barbeque mechanism assembly of claim 11, wherein the bypass lever and the bypass lever rod form a trapezoidal shape.

13. The automatic barbeque mechanism assembly of claim 11, wherein the bypass mechanism further comprises an activation rod mounted to an end of the bypass lever rod on the exterior of the oven.

14. The automatic barbeque mechanism assembly of claim 14, wherein the activation rod includes a handle for grasping and pivoting the bypass lever mechanism.

15. The automatic barbeque mechanism assembly of claim 10, further comprising a latch to hold the bypass mechanism in place.

16. An automatic barbeque mechanism assembly, comprising a cooking oven, a conveyor mechanism mounted in the oven, a sauce tank mounted in the oven for holding sauce, a food carrying mechanism connected to the conveyor means for carrying food products to be cooked within the oven and into the sauce tank so as to dip the food products into the sauce, and a bypass mechanism for preventing the food carrying mechanism from dipping into the sauce wherein the bypass mechanism can be activated from the exterior of the cooking oven with one hand.

17. The automatic barbeque assembly of claim 17, wherein the bypass mechanism includes a bypass lever, permanently affixed to a bypass lever rod, the bypass lever rod being rotatably mounted within the oven.

18. An automatic barbeque mechanism assembly of claim 17, wherein a portion of the bypass lever rod extends through an opening in the oven and rotates therein.

19. An automatic barbeque mechanism assembly of claim 17, wherein the bypass mechanism includes an activation rod mounted to the bypass lever rod on the exterior of the oven.

20. A barbeque assembly of claim 17, wherein the activation rod includes a handle for activating the bypass mechanism.

21. An automatic barbeque assembly of claim 17, further comprising a latch to hold the bypass mechanism in place.

22. An automatic cooking assembly comprising a cooking oven, a heating mechanism, a cooking process control unit, and a temperature sensing mechanism for sensing the temperature in the oven, said cooking process control unit controlling the cooking of a food product by calculating the temperature for which the product has been cooking at incremental segments of time and adding the associated segments of time and temperature together to determine a total temperature/time cooking component for the food product and comparing said total against the preprogrammed target for temperature/time.

23. The cooking assembly as set forth in claim 21 wherein the process control unit sounds an alarm and stops the cooking process for removal of the cooked food product when the preprogrammed target has been attained.

24. The cooking assembly as set forth in claim 22, wherein the cooking process control unit controls the temperature in the oven by controlling the heating mechanism.

25. The cooking assembly as set forth in claim 24, further comprising a water valve controlled by the cooking process control unit such that if the temperature in the oven exceeds a preset value, the process control unit opens a valve to spray water in the oven and reduce the temperature.

26. The cooking assembly as set forth in claim 22, wherein the cooking control unit controls a wash cycle for washing the interior of the oven.

27. The cooking assembly as set forth in claim 22, further comprising multiple food carrying mechanisms, a conveyor for carrying the food carrying mechanisms through the oven, and a conveyor proximity sensor for determining the location of each food carrying mechanism.

28. An automatic cooking assembly comprising a cooking oven, a conveyor's mechanism on the oven, a sauce tank in the oven for holding a sauce, a food carrying mechanism connected to the conveyor mechanism for carrying the food products within the oven and into the sauce, a cooking process control unit and a bypass mechanism having bypass lever within the oven so as to prevent the food cooking mechanism from dipping into the sauce when the lever is pivoted upward, said bypass mechanism being automatically controlled by said cooking process control unit.

29. The automatic cooking assembly as set forth in claim 28 including a bypass lever sensor for determining the position of the bypass lever.
